(19) United States
(12) Patent Application Publication
(10) Pub. No.: US 2014/0374581 A1
(43) Pub. Date: Dec. 25, 2014

(54) METHOD AND STRUCTURE FOR PLASMONIC OPTICAL TRAPPING OF NANO-SCALE PARTICLES

(71) Applicant: The Board of Trustees of the Leland Stanford Junior University, Palo Alto, CA (US)

(72) Inventors: Jennifer Anne Dionne, Palo Alto, CA (US); Amr Ahmed Essawi Saleh, Stanford, CA (US)

(73) Assignee: The Board of Trustees of the Leland Stanford Junior University, Palo Alto, CA (US)

(21) Appl. No.: 14/209,904

(22) Filed: Mar. 13, 2014

Related U.S. Application Data
(60) Provisional application No. 61/779,528, filed on Mar. 13, 2013.

(51) Int. Cl. G21K 1/00

(52) U.S. Cl. CPC G21K 1/006
USPC 250/251

(57) ABSTRACT

Methods and article for optically trapping nano-sized objects by illuminating a coaxial plasmonic aperture are disclosed.

### STATEMENT OF RELATED CASES

This case claims priority to U.S. Provisional Patent Application Ser. No. 61/779,528 filed on Mar. 13, 2013, which application is incorporated by herein by reference.

### STATEMENT REGARDING FEDERALLY-SPONSORED RESEARCH

This invention was made with Government support under contract FA9550-11-1-0024 awarded by the Air Force Office of Scientific Research. The Government has certain rights in the invention.

### FIELD OF THE INVENTION

The present invention relates to optical trapping of nano-sized objects.

### BACKGROUND OF THE INVENTION

Electromagnetic beams can serve as “tweezers,” enabling small objects to be accelerated, manipulated, or trapped using light alone. Optical tweezers were first introduced in 1970, using a laser beam to trap dielectric beads in lower-refractive-index media. Upon interaction with the laser, the bead was both accelerated in the direction of the beam and drawn toward the regions of high optical intensity.

Optical tweezers are a powerful means of probing and controlling micrometer-scale objects. In the biosciences, for example, optical tweezers have been used for bacterial trapping as well as noninvasive manipulation of organelles and filaments within individual living cells. They have also been used to study bio-molecular systems and the physics of molecular motors, ranging from kinesin and myosin to the polymerases involved in DNA transcription and replication. Optical traps have further enabled cooling of neutral atoms as well as translation, rotation, and assembly of relatively large nanowires and nanoparticles.

Despite these advances, optical trapping and manipulation of individual particles with sizes smaller than the wavelength of light remains a considerable challenge. The problem is inherent to the light beam itself. Optical trapping typically uses light in the visible spectrum (i.e., wavelengths between 400 and 700 nanometers) so that the specimen can be seen as it is manipulated. Due to the diffraction limit of light, the smallest space in which optical tweezing can trap a particle is approximately half the wavelength of the light beam; in the visible spectrum, this is about 200 nanometers (nm). If the specimen in question is much smaller than 200 nm, only very loose control of the specimen is possible since, relative to its size, the specimen is being trapped in a much larger potential well.

Furthermore, the optical force that light can exert on an object diminishes as the size of an object decreases. More particularly, in the Rayleigh regime (i.e., particle size smaller than the wavelength of light), optical forces on spherical particles scale with the third power of the particle's radius. As a consequence, optical forces diminish very quickly as particle size is reduced. Since the diffraction limit constrains the achievable intensity gradient, overcoming this reduction in force typically requires an increase in the illuminating optical intensity. But there are constraints to increasing intensity; in particular, increased intensity can damage the sample. It has been predicted, for example, that a 1.5 W laser beam could trap particles between 9 and 14 nm in diameter, depending on the refractive index of the particle. But such high optical powers would rapidly burn the particle.

Researchers have tried to circumvent this size limitation by tethering nano-sized molecular specimens to micrometer-scale dielectric beads that can be stably trapped and manipulated. The problem with such an approach is that a molecule might behave quite differently when tethered to what is effectively giant anchor than it would when un-tethered.

Recently, a technique called “plasmonic” tweezing has been used to extend conventional optical trapping to the sub-optical-wavelength regime. Plasmonic traps rely on excitation of surface plasmon-polaritons, which result from the coupling of light with the mobile conduction electrons at the interface of a conductor and insulator. That is, when light interacts with these mobile electrons, the light is scattered and sculpted into electromagnetic waves called “plasmon-polaritons.” These oscillations have a very short wavelength compared to visible light, enabling them to trap small specimens more tightly than is otherwise possible.

These electromagnetic modes are capable of confining light beyond the diffraction limit and are characterized by an exponential decay of electromagnetic fields away from the interface. These properties are very important for trapping applications; the former property significantly reduces the trapping volume, while the latter enhances the resulting optical forces due to the strong field gradient.

Several recent studies have demonstrated the feasibility of plasmonic optical trapping. In 2009, it was shown that plasmonic nano-antennas can trap 200 nm polystyrene particles using 300 mW (0.01 mW/μm²) of illumination power. In 2011, trapping and rotation of 110 nm polystyrene beads were achieved using plasmonic nano-pillars with an illumination intensity of 10 mW/μm². More recently, trapping of 20 nm polystyrene particles was achieved within a plasmonic nano-cavity formed by a nano-pore and double nano-hole aperture. These demonstrations combined the plasmonic trap with “self-induced back action trapping,” allowing the required illumination power to remain below 10 mW.

In the biosciences, nano-photonic and plasmonic structures have enabled optical trapping of X-DNA molecules and a single bovine serum albumin molecule with a hydrodynamic radius of 3.4 nm. Theoretical studies have shown that optical trapping of particles as small as 10 nm is possible within silicon slot waveguides and hybrid plasmonic waveguides. However, efficient trapping of sub-10-nm particles still remains a considerable challenge.

### SUMMARY OF THE INVENTION

The present invention provides a way to trap particles smaller than 10 nanometers and as small as about 2 nanometers.

In accordance with the illustrative embodiment, a coaxial plasmonic aperture is used to focus electromagnetic energy to a region much smaller than a diffraction-limited spot, thereby functioning as an optical trap for extremely small particles.

In accordance with the illustrative embodiment, the coaxial plasmonic aperture comprises a cylindrical core, a channel in the form of an annulus or ring that surrounds the core, and a cladding that covers the ring. In the illustrative embodiment, the core comprises silver and has a diameter of 120 nm, the channel comprises silicon dioxide and has a width of 25 nm, and the cladding comprises silver. The width of the cladding is arbitrary and is typically similar to the radius of the core. The length of the aperture is 150 nm.

In operation, a particle is positioned at one end of the aperture. The other end of the aperture is illuminated with light, such as from a laser. As light propagates through the silicon dioxide ring, it creates plasmons at the interface of the silver and silicon dioxide. The plasmons travel along the aperture and emerge at the other end as a powerful, concentrated beam of optical energy. The particle interacts with the optical field and is thereby trapped. The resulting optical forces on the particle vary with both the particle size and the dimensions of the aperture itself. The particle can be metallic or dielectric.

The transmittance spectrum of the coaxial plasmonic aperture will exhibit certain maxima that arise from Fabry-Perot resonances within the (finite thickness) aperture. In the illustrative embodiment, with the dimensions of the coaxial plasmonic aperture as indicated and when illuminated with a linearly polarized plane wave, these maxima—resonant plasmonic wavelengths—occur at wavelengths of 692 nm and 484 nm. Thus, the aperture effectively provides two discrete traps. This is mode of operation is particularly useful for applications in which a particle is to be precisely manipulated (e.g., studied, moved to a precise location, etc.).

In another mode of operation, circularly polarized light can be used. This results in a “donut” shaped trap and enables more particles to be trapped than when using linearly polarized light. Such a mode of operation is useful, for example, for filtration applications.

Unlike any other plasmonic traps, a coaxial plasmonic aperture in accordance with the illustrative embodiment of the invention traps particles at the surface of the aperture, rather than inside of it. As a consequence, the trapped particle can be further manipulated and processed.

Furthermore, a coaxial plasmonic aperture in accordance with the illustrative embodiment of the invention has greater transmission efficiency compared to the prior art approaches to plasmonic trapping. This high efficiency can equate to reduced power requirements.

### BRIEF DESCRIPTION OF THE DRAWINGS

FIG. 1A depicts a coaxial plasmonic aperture in accordance with the illustrative embodiment of the present invention.

FIG. 1B depicts a sectioned view of the coaxial plasmonic aperture of FIG. 1A.

FIG. 1C depicts a cross-sectional view of the coaxial plasmonic aperture of FIG. 1A.

FIG. 1D depicts a particle trapped by the near field transmitted through the aperture.

FIG. 2 depicts a first alternative embodiment of a coaxial plasmonic aperture in accordance with the present invention.

FIG. 3A depicts a second alternative embodiment of a coaxial plasmonic aperture in accordance with the present invention.

FIG. 3B depicts a third alternative embodiment of a coaxial plasmonic aperture in accordance with the present invention.

FIGS. 4A and 4B depict rotation of the position of trapped particles around the axis of the aperture by rotating the polarization direction of the linearly polarized laser that illuminates the coaxial plasmonic aperture.

FIG. 5A depicts a fourth alternative embodiment of a coaxial plasmonic aperture in accordance with the present invention.

FIG. 5B depicts a fifth alternative embodiment of a coaxial plasmonic aperture in accordance with the present invention.

FIG. 6 depicts an array of coaxial plasmonic apertures.

### DETAILED DESCRIPTION

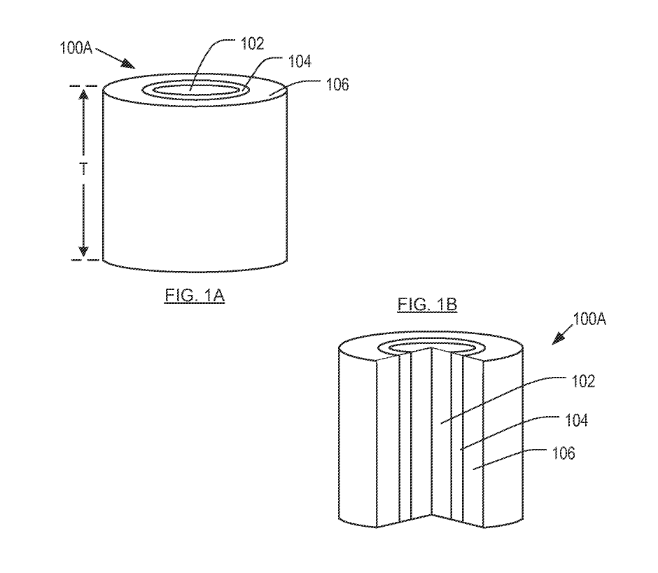

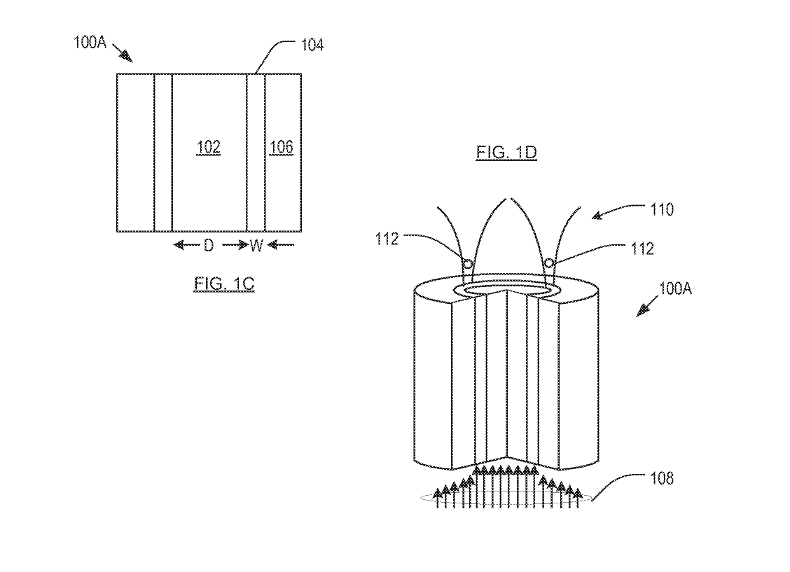

FIGS. 1A-1D depict coaxial plasmonic aperture 100A in accordance with the illustrative embodiment of the present invention. Coaxial plasmonic aperture 100A comprises core 102, channel 104, and cladding 106, inter-related as shown.

In some embodiments, core 102 has a cylindrical shape. In some alternative embodiments, core 102 has a polygonal perimeter. Core 102 preferably comprises a metal, more preferably a noble metal. In some alternative embodiments, highly-doped semiconductors or metals can be used. In the illustrative embodiment, core 102 comprises silver.

A change in the core material will result in a change in the plasmonic resonance frequency of coaxial plasmonic aperture 100A. Thus, changing the core material results in a shift in the operating range of coaxial plasmonic aperture 100A, which, as a function of trapping application, might be useful. Those skilled in the art, after reading this specification, will be able to determine the shift in operating range of the co-axial plasmonic aperture as a function of a change in the material of core 102 via simple experimentation as desired for use in a given application.

Channel 104 is disposed around core, in the form of an annulus or ring. The channel comprises a material that enables propagation of the electromagnetic radiation that powers the trap. The channel thus functions as the aperture.

In the illustrative embodiment, light in the visible range is used as the illumination source; as such, the channel preferably comprises a dielectric material. In the illustrative embodiment, channel 104 comprises silicon dioxide. Other dielectrics suitable for use as channel 104 when powering the trap with light in the visible range include silica, silicon oxy-nitride, silicon nitride, borosilicate, phosphosilicates, sapphire, and other glasses. In principle, any (electrical) insulator can be used; however, use of any particular material will cause a shift (typically very slight) in the resonant plasmonic wavelength as a function of the refractive index of the material.

Other materials suitable for use as channel 104 include dielectrics with relatively higher refractive indices, such as gallium phosphide. The use of such materials will result in larger shifts in the resonant plasmonic wavelengths, hence resulting in a change in the optimal operating wavelength(s) of aperture 100.

In the illustrative embodiment, the coaxial plasmonic aperture 100A has a thickness T of 150 nm. This thickness is selected to ensure that no light will be transmitted through the aperture 100 at regions other than channel 104. In other words, light should not be transmitted through core 102 or cladding 106. Yet, thickness T is ideally no larger than is required for core/cladding to be opaque so that losses of optical energy through channel 104 are as low as possible. Those skilled in the art will be able to determine an acceptable thickness based on the material used as core 102/cladding 106, the material used as channel 104, and optical power constraints.

In the illustrative embodiment, core 102 has a diameter of 120 nm. The diameter of core 102 can, like materials selection, be used to affect the operating wavelength of aperture 100A. The larger core 102, the greater the red-shift in the resonant plasmonic wavelength for a given channel thickness and aperture thickness.

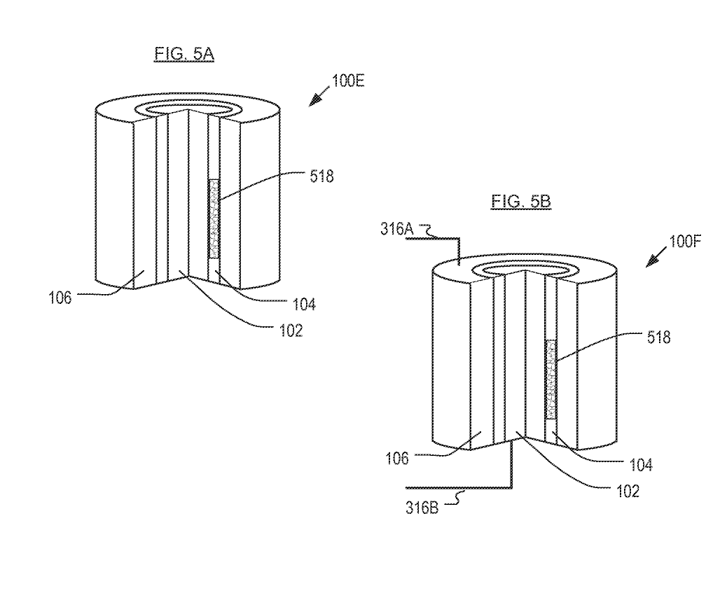

Also, as core 102 gets wider, so does the total diameter of aperture 100A. Increasing the total diameter of aperture 100A results in a wider trapping potential in the y-direction. See Saleh and Dionne, “Toward Efficient Optical Trapping of Sub-10-nm Particles with Coaxial Plasmonic Apertures,” Nano Lett., 12, p 5581-5586 (American Chemical Society 2012), which is incorporated by reference herein. As shown in FIG. 4(c) of the Saleh and Dionne article, which shows a cross section of the optical trapping potential in the y-direction, the cross section increases in width as the diameter of the aperture increases, which might be undesirable as a function of application specifics. Decreasing the diameter of the core reduces the transmission efficiency of the aperture but will result in a tighter trapping potential in the y-direction.

In the illustrative embodiment, channel 104 has a width of 25 nm. The width of the channel, at least at the input side, must be large enough to couple sufficient optical power into the channel. It is within the capabilities of those skilled in the art to determine a minimum acceptable width so as to couple sufficient optical power into channel 104. Furthermore, the width affects the size of the particle that can be trapped.

Cladding 106 surrounds channel 104. Suitable materials for cladding 106 are the same as those for core 102, although the core and the cladding do not have to be the same material. However, in typical geometries wherein two resonant plasmonic modes are coupled, the geometry is symmetric; that is, core 102 and cladding 106 will comprise the same material.

The width of cladding 106 is preferably greater than the “skin depth” of the conductor used for the cladding. As such, a width of 20 nm or more is sufficient for noble metals. Skin depths for conductors are known and those skilled in the art can set a suitable width for cladding 106 as a function of skin depth.

As previously noted, coaxial plasmonic aperture 100A exhibits certain resonant plasmonic wavelengths. These resonant wavelengths are primarily a function of the thickness T of aperture 100 and phase shifts due to reflections at the waveguide facets (i.e., the ends of channel 104). To a somewhat lesser extent, resonant plasmonic wavelengths can be altered as a function of materials choices, as previously noted. Changes in the resonant plasmonic wavelength thus change the preferred operating wavelengths of aperture 100A. The choice as to the desired operating wavelength is primarily a function of the nature of the particle(s) that are to be trapped.

Referring now to FIG. 1D, in operation, one end of coaxial plasmonic aperture 100A is illuminated with linearly polarized light in the visible range. Illuminating the coaxial plasmonic aperture results in the emission of energy from the forward edge of channel 104. The energy provides a dual-trapping potential well in which to confine a particle. Particle 112, positioned at the non-illuminated end of aperture 100A, interacts with and is trapped by near field energy 110 emitted from the edge of channel 104.

Channel 104 having a width of 25 nm is capable of trapping a 5 nm particle with optical power of less than 100 mW transmitted through the trap. This is based on a figure of 10 kT as a minimum threshold for establishing a stable optical trap. Input power requirements are based on the efficiency at which input optical power is coupled to channel 104 and the efficiency of transmission through the channel.

To trap a particle smaller than 5 nm, such as a 2-nm particle, will require substantially more power or an alternative configuration.

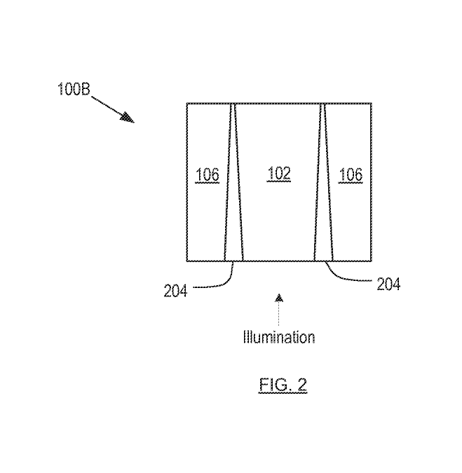

FIG. 2 depicts coaxial plasmonic aperture 1008, which is one such alternative configuration of the illustrative embodiment. Channel 204 of aperture 100B is tapered so that the output end of the channel is narrower than the input end. In the illustrative embodiment, the width of channel 204 narrows from 25 nm at the input end to 5 nm at the output end. Results show that using coaxial plasmonic aperture 1008, a 2 nm particle interacting with the near field 2 nm away from the output end of channel 204 experiences a trapping potential of 60 kT/100 mW (wavelength of 811 nm, particle in air), which is well above the minimum 10 kT for stable confinement. This means that only 17 mW is required to confine the particle.

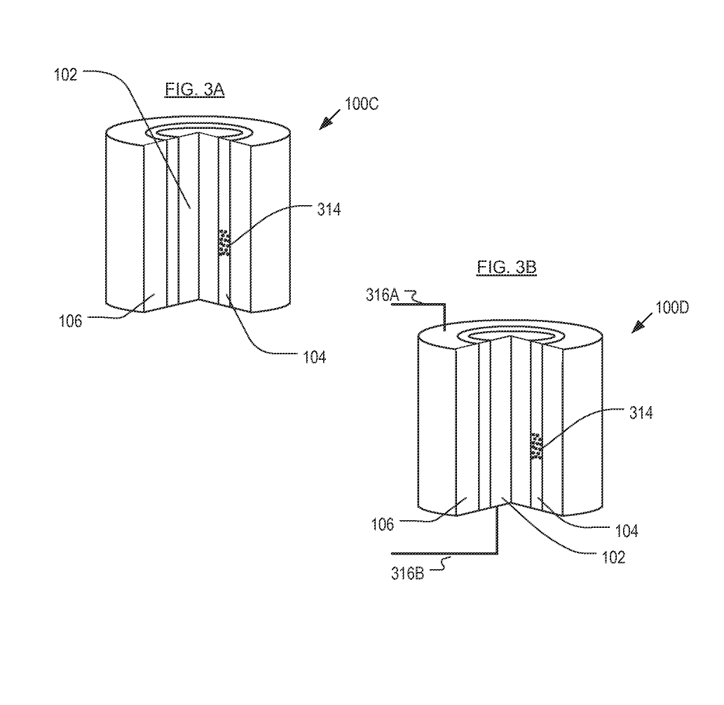

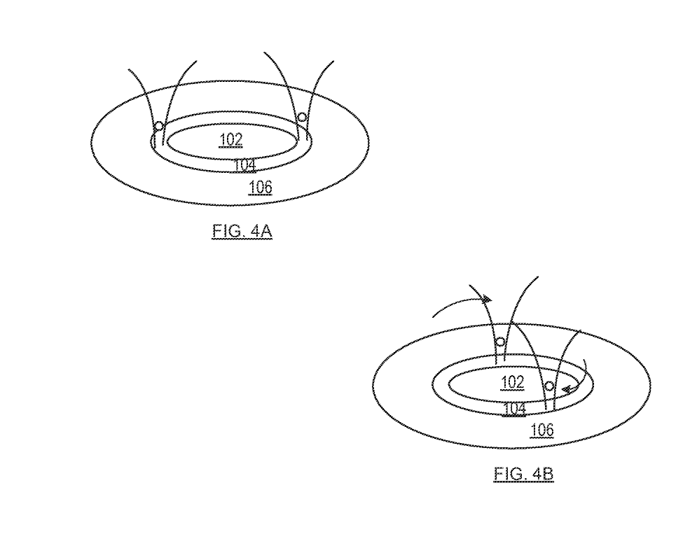

In some embodiments, optically-active media is incorporated into the channel of a coaxial plasmonic aperture, such that gain is experienced therethrough. The gain profile can be controlled so that an asymmetric trapping potential is generated. This can be used to study the kinetics of individual molecules in different environments. The optically-active media can occupy some or all of the channel. Examples of optically-active media suitable for use in conjunction with the present invention include, without limitation, rare earth ions and various dyes. FIG. 3A depicts coaxial plasmonic aperture 100C having optically-active media 314 in channel 104.

In some further embodiments, electrical contacts are disposed on core 102 and cladding 106, thereby providing electrical control of aperture 102. This can be used, for example, in embodiments in which an optical-gain medium is added to the channel, wherein instead of pumping the gain medium optically, it is pumped electrically via the contacts. FIG. 3B depicts coaxial plasmonic aperture 100D having electrodes 316A and 316B for electrically pumping gain medium 314 in channel 104.

In yet some additional embodiments, the polarization of the illuminating light can be altered to manipulate a confined particle. For example, rotating the polarization direction of the linearly polarized laser that illuminates the coaxial plasmonic aperture results in rotation of the position of the trapped particle(s) around the axis of the aperture. Such rotation is depicted in FIGS. 4A and 4B, which depicts an end view of the aperture. In the case of a linearly polarized laser, for example, the polarization of the illumination light can be rotated by simply rotating the laser. Rotation can also be effected electronically.

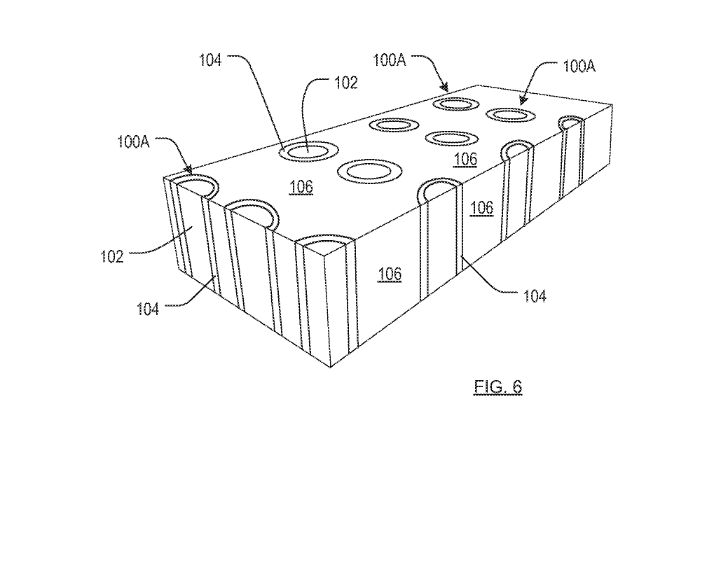

In some further embodiments, the dimensions of the coaxial plasmonic aperture or the refractive index of the channel thereof is passively or actively modulated (such as using ferroelectric, piezoelectric, or electro-optically-active materials). This enables the trapping wavelength to be tuned. Examples of such materials include, without limitation, lithium niobate (piezoelectric), barium titanate (ferroelectric), lead titanate (ferroelectric), and the like. FIG. 5A depicts an embodiment of passively modulated coaxial plasmonic aperture 100E. FIG. 5B depicts an embodiment of an actively modulated coaxial plasmonic aperture 100F. In both of these embodiments, some or all of channel 104 includes ferroelectric, piezoelectric, or electro-optically-active material 518. Coaxial plasmonic aperture 100F includes electrodes 316A and 316B by which channel 104 is actively modulated.

In still further embodiments, a plurality of coaxial plasmonic apertures 100A are arranged in an array to trap many particles. This can be used as a basis for nano-scale particle filters and sensors. Arranging the apertures in arrays, such as depicted in FIG. 6, significantly enhances overall efficiency, as well.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. An article comprising:
a coaxial plasmonic aperture, wherein the coaxial plasmonic aperture includes:
a core, wherein the core comprises a metal;
a channel, wherein the channel surrounds the core, and wherein the channel comprises a dielectric and has a width of 25 nm; and
a cladding, wherein the cladding surrounds the core and compromises metal; and
a laser, wherein the laser is positioned to illuminate a first end of the coaxial plasmonic aperture.

2. The article of claim 1 wherein the core comprises a noble metal.

3. The article of claim 2 wherein the core comprises silver.

4. The article of claim 2 wherein the cladding comprises the same metal as the core.

5. The article of claim 1 wherein the channel comprises silicon dioxide.

6. The article of claim 3 wherein the channel comprises silicon dioxide.

7. The article of claim 1 wherein the coaxial plasmonic aperture has a thickness of 150 nm.

8. The article of claim 1 wherein the core has a diameter of 120 nm.

9. The article of claim 1 wherein the core is cylindrical.

10. The article of claim 9 wherein the channel comprises a ring.

11. The article of claim 1 wherein the channel tapers from a width of 25 nm proximal to the first end of the coaxial plasmonic aperture to a width of less than 25 nm at a distal end of the coaxial plasmonic aperture.

12. The article of claim 11 wherein the width that is less than 25 nm is 5 nm.

13. The article of claim 1 wherein the channel comprises an optical gain media.

14. The article of claim 13 wherein a first electrical contact is disposed on the core and a second electrical contact is disposed on the cladding.

15. The article of claim 1 wherein the channel comprises a material selected from the group consisting of ferroelectric, piezoelectric, and electro-optically active.

16. A method for trapping a particle comprising:
positioning the particle near an output end of a waveguide; and
illuminating an input end of the waveguide with light, wherein the waveguide:
(a) comprises a dielectric material;
(b) has an interface with a layer comprising a conductor;
(c) has a width of 25 nm at the first end.

17. The method of claim 16 and further wherein a width of the output end of the waveguide is less than 25 nm.

18. The method of claim 16 wherein the operation of illuminating an input end of the waveguide with light further comprises illuminating the input end of the waveguide with linearly polarized light.

19. The method of claim 18 further comprising rotating the polarization of the light.

20. The method of claim 16 wherein the operation of illuminating an input end of the waveguide with light further comprises illuminating the input end of the waveguide with linearly polarized light.

21. The method of claim 16 further comprising applying gain to the light within the waveguide.

22. The method of claim 16 and further comprising altering a refractive index of the dielectric material.

23. The method of claim 16 and further comprising altering a dimension of the waveguide.
